(19) United States
(12) Patent Application Publication
(10) Pub. No.: US 2014/0268666 A1
(43) Pub. Date: Sep. 18, 2014

(54) ILLUMINATED BEVERAGE CONTAINER

(71) Applicant: PEOPLE WATER, INC., A UTAH CORPORATION, Pleasant Grove, UT (US)

(72) Inventor: Ken Bretschneider, Lindon, UT (US)

(73) Assignee: People Water, Inc., a Utah corporation, Pleasant Grove, UT (US)

(21) Appl. No.: 13/798,825

(22) Filed: Mar. 13, 2013

(51) Int. Cl. F21V 33/00

(52) U.S. Cl. CPC F21V 33/0036
USPC 362/101

(57) ABSTRACT

Exemplary beverage containers with compartments and methods of making and using such bottles are disclosed. Some embodiments of an exemplary beverage container may include a body formed of a thermoplastic resin, the body forming a liquid container, and a compartment formed in the base of the container. The compartment may have an illumination element to illuminate the beverage container and its contents.

### FIELD

This application relates generally to beverage containers. In particular, this application relates to flask-shaped beverage containers with a secondary compartment for holding illuminating elements.

### BACKGROUND

In recent years, sales for bottled water and flavored beverages have exploded. Special events and nightclubs represent a very large share of the bottled water market.

Several additives and accessories for bottled water are also being marketed to capitalize on the availability and convenience of bottled water. Some efforts have been made to include additives and accessories with the bottle, hut none have been particularly well-received by the market or cost-effective to produce.

### SUMMARY

Exemplary beverage containers with compartments and methods of making and using such bottles are disclosed. Some embodiments of an exemplary beverage container may include a body formed of a thermoplastic resin, the body being translucent; an opening in the body for accessing the interior of the body; a compartment formed in a base of the body; an illumination element held within the compartment; and wherein the illumination element provides lighting to the interior of the body. In some embodiments, the illumination element may be a chemical light. In some embodiments, the body may be transparent. The body may also be flask-shaped. The opening may be selectively closable to provide selective access to beverage within the body.

In some embodiments, the compartment may include an access tab. The container may also include a cover, the cover providing access to the illumination element within the compartment. The cover may be a sticker. The cover may extend over only a portion of the compartment. Similarly, the cover may be formed as a cap covering the entire base of the container.

In some embodiments, the beverage container may be displayed by providing a beverage container, the beverage container including, a translucent body, the body forming a liquid container, a compartment formed in a base of the body, and placing an illumination element within the compartment, where in the illumination element illuminates the translucent body and any liquid within the liquid container. The illumination element may be an electronic illumination element. Similarly, the illumination element may be a chemical illumination element. The transparent body may be formed from PET, and may include a single opening opposite the compartment.

### BRIEF DESCRIPTION OF THE DRAWINGS

The following description can be better understood in light of Figures, in which:

FIG. 1 illustrates an exemplary beverage container with compartment;

FIG. 2 illustrates a bottom view of the exemplary beverage container with compartment of FIG. 1;

FIG. 3 illustrates an exemplary beverage container with compartment and illuminating element;

FIG. 4 illustrates a bottom view of the exemplary beverage container with compartment and illuminating element of FIG. 3;

FIG. 5 illustrates an exemplary beverage container with compartment and illuminating element;

FIG. 6 illustrates a side view of an exemplary beverage container with compartment and illuminating element;

FIG. 7 illustrates an orthogonal view of an exemplary beverage container with compartment and illuminating element; and

FIG. 8 illustrates an exemplary beverage container with compartment and base cap.

Together with the following description, the Figures demonstrate and explain the principles of exemplary beverage containers with compartment and methods for making and using the exemplary beverage containers with compartment. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry.

FIGS. 1-7 illustrate exemplary beverage containers with compartment 100. Beverage container 100 may include a translucent or transparent body 110 and an illumination element 150 held within a compartment 134 in the base 130 of the container with a cover 140. Illumination element 150 may provide illumination to body 110, or to any contents of container 100. The illumination may provide a pleasing aesthetic feature to container 100 for sale or during use. Similarly, a color of illumination may be selected to help users differentiate their beverage from others' in a group setting.

Beverage container 100 may include body 110, top 120, and base 130. Container 100 may further include opening 128 in top 120. Opening 128 may be any conventional bottle opening, such as for personal consumption, or much larger for bulk delivery. Some embodiments may include threads that correspond to a cap to make container 100 resealable. Base 130 may include compartment 134. Compartment 134 may be configured to accommodate illumination element 150. Cover 140 may hold illumination element 150 within compartment 134.

In various embodiments, body 110 may be formed of polyethylene terephthalate (PET), polycarbonate, glycol modified polyethylene terephthalate (PETG), polymethlamethacrylate (acrylic), glass, or other suitable translucent or transparent material. Such materials may be used to form all or part of container 100. In some embodiments, plastics, aluminum, steel, or any other suitable material for all or parts of beverage container 100. Beverage container 100 may be suitable for holding various types of beverages, such as water, soft drink, energy drink, sports drink, etc.

For example, body 110 may be formed of polycarbonate, and may include a cap formed of high-density polyethylene, and compartment cap 130 may be formed of aluminum. Or, in another example, body 110 may be formed of transparent PETG, and a cap may be formed with black PET. In another embodiment, all components may be formed from PET and each may be translucent, transparent, colored, opaque, etc., as desired. Container 100 may be formed using blow molding, other thermoforming, or any other manufacturing technique used to form beverage containers.

In some embodiments, container 100 may formed such that it has a substantially flask-shaped with a closed bottom 130 and top 120, top 120 may include opening 128 and a cap, and bottom 130 having compartment 134. In other embodiments, container 100 may be any suitable shape for holding and providing beverages to individuals. Compartment 134 may be at least partially covered with cover 140. Compartment 134 may be formed to accommodate illumination element 150. Compartment 134 may further include tab access 136 to provide easy access to open compartment 134. Compartment 134 may be formed such that illumination element 150 snaps into compartment 134 and cover 140 may then be redundant. Similarly, tab 136 may also provide a place for fingers to pull illumination element 150 out of compartment 134.

Cover 140 may be included to secure illumination element 150 within compartment 134. Cover 140 may be a sticker formed of a plastic or paper material, may be a plastic plate, or may be any other form or design to hold illumination element 150 within compartment 134. In some embodiments, cover 140 may include features to cooperatively engage with compartment 134 to hold illumination element 150 in place. Cover 140 may by any suitable shape and size to secure illumination element 150 within compartment 134. For example, cover 140 may be a square sticker, as illustrated in FIG. 4, covering only a portion of compartment 134. In such embodiments, a portion of tab 136 may be left uncovered to allow for a user to easily grab and remove cover 140.

Illumination element 150 may be a miniature chemical light, such as Cyalume® mini chemlights, which have a length of about 1.5″ and about a ¼″ diameter. In other embodiments, illumination element 150 may be an electronic illuminator using LED or other lights, and may be any shape and size sufficient to provide some amount of lighting to the contents of container 100. Of course, the shape of compartment 134 may be formed to coordinate with the shape and size of illumination element 150.

Container 100 may be packaged and sold with water or other beverage with unactivated illumination element 150 stored in compartment 134 and held in place by cover 140. A user may then open cover 140, remove illumination element 150 from compartment 134, activate illumination element 150, replace illumination element 150 in compartment 134, and then replace cover 140 to hold illumination element 150 in place. In other embodiments, multiple illumination elements 150 may be included so that the user may select a particular color, or change colors during use. Similarly, illumination element 150 may be able to change colors, patterns, or other features, such as with electronic LED devices commonly used in toys and other applications.

In some embodiments, container 100 may be intended for single-use and illumination element 150 may be reusable with different containers. In other embodiments, container 100 may be intended to be reusable and illumination element 150 may be single-use and replaceable. Similarly, both container 100 and illumination element 150 may be single use or both may be reusable. In other embodiments illumination element 150 may be replaced with anything that is useful in cooperation with a beverage container. For example, a blister pack of powder for mixing into the contents of body 110 may be included, or may be tablets to provide carbonation, or medicament.

In some embodiments, sales of container 100 at a sporting event may be enhanced by including illumination elements in compartment 134 that would illuminate container 100 in the color or colors of a home team. Similarly, a night-club owner may create a design using containers 100 illuminated with various colors to encourage a desired ambiance and to improve sales. In other embodiments, different colors may be used to distinguish which container belongs to which person in a group of persons. For example, one person may have a red illuminated container and another in the same group may have a blue illuminated bottle to distinguish which container belongs to whom.

FIG. 8 illustrates an exemplary beverage container with compartment 200. Beverage container 200 may be substantially similar, with similar components, with cover 240 being a base cap covering the entire base 230 of container 200. Container 200 may include a translucent or transparent body 210 and an illumination element 250 held within a compartment 234 in the base 230 of the container with a cover 240. Illumination element 250 may provide illumination to body 210, or to any contents of container 200. Cover 240 may be formed of a different color or different material than body 210. For example, cover 240 may have a differing degree of translucense than body 210 to provide a particular effect when container 200 is illuminated by illumination element 250. Similarly, cover 240 may be formed of aluminum or a plastic with a metalized finish as in contrast to a transparent body 210.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A beverage container comprising:
a body formed of a thermoplastic resin, the body being translucent;
an opening in the body for accessing the interior of the body;
a compartment formed in a base of the body;
an illumination element held within the compartment; and
wherein the illumination element provides lighting to the interior of the body.

2. The container of claim 1, wherein the illumination element is a chemical light.

3. The container of claim 2, wherein the body is transparent.

4. The container of claim 3, wherein the body is flask-shaped.

5. The container of claim 1, wherein the opening is selectively closable to provide selective access to beverage within the body.

6. The container of claim 1, wherein the compartment includes an access tab.

7. The container of claim 1, further comprising a cover, the cover providing access to the illumination element within the compartment.

8. The container of claim 7, wherein the cover is a sticker.

9. The container of claim 7, wherein the cover extends over only a portion of the compartment.

10. The container of claim 7, wherein the cover is formed as a cap covering the entire base of the container.

11. The container of claim 1, wherein the thermoplastic resin is PET.

12. A method of displaying a beverage container, the method comprising:
providing a beverage container, the beverage container including,
a translucent body, the body forming a liquid container,
a compartment formed in a base of the body; and
placing an illumination element within the compartment, where in the illumination element illuminates the translucent body and any liquid within the liquid container.

13. The method of claim 12, wherein the illumination element is an electronic illumination element.

14. The method of claim 12, wherein the illumination element is a chemical illumination element.

15. The method of claim 12, wherein the translucent body is transparent.

16. The method of claim 12, wherein the beverage container contains water.

17. The method of claim 12, wherein transparent body is formed from PET.

18. The method of claim 12, wherein the body includes a single opening opposite the compartment.

19. The method of claim 12, further comprising a providing a selectively removable cover, the cover at least partially covering the compartment.

20. The method of claim 11, wherein the cover is opaque.
